(19) United States
(12) Patent Application Publication
(10) Pub. No.: US 2026/0236802 A1
(43) Pub. Date: Aug. 13, 2026

(54) LEARNING DEVICE, DETECTION SYSTEM, LEARNING METHOD, AND LEARNING PROGRAM

(71) Applicant: NTT, Inc., Tokyo (JP)

(72) Inventors: Yuki YAMANAKA, Musashino-shi, Tokyo (JP); Takuya MINAMI, Musashino-shi, Tokyo (JP); Masanori SHINOHARA, Musashino-shi, Tokyo (JP); Yo KANEMOTO, Musashino-shi, Tokyo (JP); Hiroto NOMURA, Musashino-shi, Tokyo (JP); Yasunori WADA, Musashino-shi, Tokyo (JP)

(73) Assignee: NTT, Inc., Tokyo (JP)

(21) Appl. No.: 19/156,460

(22) PCT Filed: Feb. 17, 2023
(86) PCT No.: PCT/JP2023/005861

§ 371 Date: Aug. 14, 2025

(51) Int. Cl. G06N 5/04

(52) U.S. Cl. CPC G06N 5/04

(57) ABSTRACT

A learning device includes a memory and processing circuitry configured to acquire a piece of communication data associated with a piece of configuration information of a device, and estimate a probability density of the piece of communication data in accordance with a type of the piece of configuration information and update parameters of a model which represents characteristics of the probability density of a piece of normal communication data.

### TECHNICAL FIELD

The present invention relates to a learning device, a detection system, a learning method, and a learning program.

### BACKGROUND ART

As the risk of cyber attacks increases in recent years, anomaly-based communication anomaly detection technology has been attracting attention as a way to protect devices from a variety of cyber attacks, including zero-day attacks.

### CITATION LIST

### Patent Literature

[PTL 1] Japanese Laid-open Patent Publication No. 2019-101982

### Non Patent Literature

[NPL 1] “Utilizing BERT for Feature Extraction of Packet Payload”, [online], [Retrieved Jan. 26, 2023], Internet <https://www.jstage.jst.go.jp/article/pjsai/JSAI2021/0/JSAI202 1_1F2GS10a04/article/-char/ja>

### SUMMARY OF INVENTION

### Technical Problem

Here, the above-described techniques in the related art have a problem in that it may not be possible to reduce the vulnerable initial learning time required for generating a learning model. For example, generating a normal communications model for anomaly detection requires a certain period of data collection and learning time, which posed the issue of the risk of being vulnerable to cyber attacks during the initial learning period.

### Solution to Problem

In order to solve the above problems and achieve the object, a learning device according to the present invention includes an acquisition part which acquires a piece of communication data associated with a piece of configuration information of a device; and a first estimation part which estimates a probability density of the piece of communication data in accordance with a type of the piece of configuration information and updates parameters of a model which represents characteristics of the probability density of a piece of normal communication data.

### Advantageous Effects of Invention

According to the present invention, it is possible to reduce the vulnerable initial learning time required until a learning model is generated.

### BRIEF DESCRIPTION OF DRAWINGS

FIG. 1 is a diagram showing an example of a configuration of a detection system according to an embodiment.

FIG. 2 is a block diagram showing an example of a configuration of a learning device according to an embodiment.

FIG. 3 is a diagram showing a VAE.

FIG. 4 is a diagram showing a conditional probability density estimation process according to an embodiment.

FIG. 5 is a diagram showing a specific example of a detection process according to an embodiment.

FIG. 6 is a flowchart for describing an example of a process flow of a detection system according to an embodiment.

FIG. 7 is a diagram showing an example of a computer which executes a learning program.

### DESCRIPTION OF EMBODIMENTS

Embodiments of a learning device, a detection system, a learning method, and a learning program according to the present application will be described in detail below with reference to the accompanying drawings. Note that the learning device, the detection system, the learning method, and the learning program according to the present application are not limited to these embodiments.

### 1. Configuration Example of System

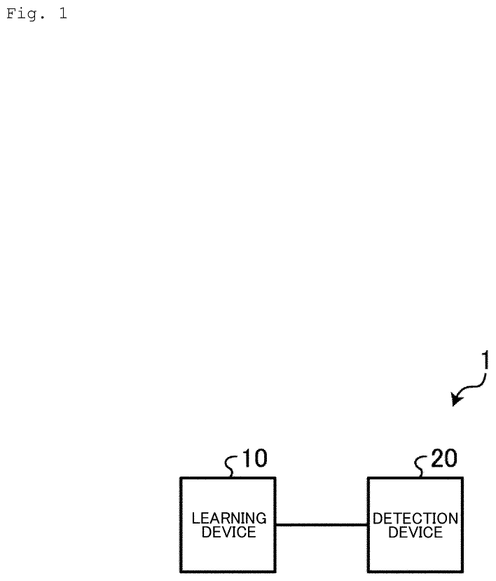

As shown in FIG. 1, a detection system 1 according to an embodiment includes a learning device 10 and a detection device 20. The learning device 10 and the detection device 20 are connected to each other, for example, via a network or the like and are also connected to an external device via a network or the like.

The learning device 10 acquires a piece of communication data linked to the piece of configuration information of the device. Also, the learning device 10 estimates the probability density of the piece of communication data according to the type of a piece of configuration information and updates the parameters of the model which represents the characteristics of the probability density of a piece of normal communication data.

The learning device 10 first acquires a piece of communication data associated with the piece of configuration information of the device. For example, the learning device 10 acquires a piece of communication data to be learned such as a piece of flow information and a piece of packet information which are linked to a piece of configuration information such as device protocols and a Software Bill Of Materials (SBOM).

Furthermore, the learning device 10 estimates the probability density of the piece of communication data according to the type of a piece of configuration information and updates the parameters of the model which represents the characteristics of the probability density of a piece of normal communication data. For example, the learning device 10 estimates the probability density of a piece of communication data corresponding to each piece of configuration information linked to the piece of communication data and updates the parameters of a model which represents the probability density of a piece of normal communication data, thereby generating a communication monitoring model in which only communications corresponding to the piece of configuration information are considered to be normal.

The detection device 20 receives a piece of configuration information and applies model parameters updated in accordance with the piece of received configuration information to estimate the probability density of the piece of communication data of the detection target. Furthermore, the detection device 20 detects the presence or absence of an abnormality in the piece of communication data of the detection target on the basis of the estimated probability density.

The detection device 20 first receives a piece of configuration information and estimates the probability density of the piece of communication data of the detection target by applying model parameters updated in accordance with the piece of received configuration information. For example, the detection device 20 receives any piece of configuration information from the outside and estimates the probability density of the piece of communication data of the detection target by applying the parameters of the communication monitoring model described above which correspond to the piece of received configuration information.

Also, the detection device 20 detects the presence or absence of an abnormality in the piece of communication data of the detection target on the basis of the estimated probability density. For example, when the estimated probability density is lower than a predetermined value set in advance, the detection device 20 detects that the piece of communication data to be detected is abnormal and notifies an external handling device or the like of the occurrence of an abnormality in the piece of communication data.

### 2. Configuration of Detection System 1

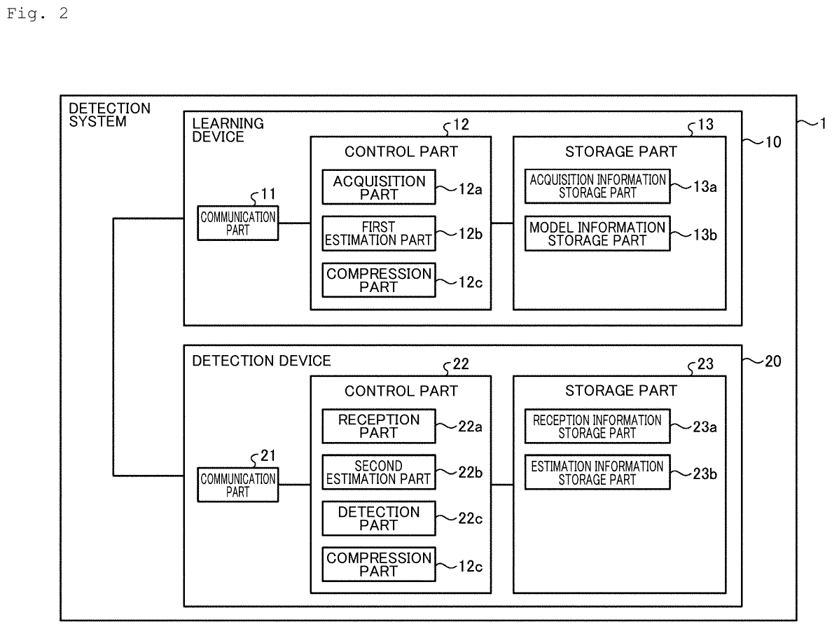

A configuration of a detection system 1 shown in FIG. 1 will be described below with reference to FIG. 2. FIG. 2 is a block diagram showing an example of the configuration of the detection system according to an embodiment. As shown in FIG. 2, the detection system 1 according to the embodiment includes a learning device 10 and a detection device 20.

The learning device 10 has a communication part 11, a control part 12, and a storage part 13 and the detection device 20 has a communication part 21, a control part 22, and a storage part 23. Furthermore, the learning device 10 and the detection device 20 are connected to each other via wire or wirelessly so that they can communicate with each other.

The communication part 11 and the communication part 21 are realized using, for example, a network interface card (NIC) or the like. The communication part 11 and the communication part 21 are connected to the learning device 10 or the detection device 20 via wired or wireless connection and transmit and receive a piece of information to and from the learning device 10 or the detection device 20. Furthermore, the communication part 11 and the communication part 21 receive a piece of communication data and a piece of configuration information from external devices via, for example, a network and also transmit any detected abnormality in the piece of communication data to the external devices.

The storage part 13 and the storage part 23 are realized by a storage device such as a random access memory (RAM) or a hard disk. The storage part 13 and the storage part 23 store a piece of data and programs required for various processes performed using the control part 12 and the control part 22, respectively. In addition, the storage part 13 of the learning device 10 includes an acquisition information storage part 13a and a model information storage part 13b which are closely relating to the present invention.

The acquisition information storage part 13a stores, for example, pieces of device configuration information such as protocols, SBOMs, and source codes acquired using the acquisition part 12a which will be described later and pieces of communication data such as a piece of flow information and a piece of packet information associated therewith.

The model information storage part 13b stores, for example, pieces of information such as parameters about a communication monitoring model in which only communication corresponding to a piece of specific configuration information which has been updated using the first estimation part 12b which will be described below is considered to be normal.

The storage part 23 of the detection device 20 includes a reception information storage part 23a and an estimation information storage part 23b which are closely relating to the present invention. The reception information storage part 23a stores, for example, a piece of specific configuration information received using the reception part 22a which will be described later. The estimation information storage part 23b stores, for example, the anomaly score of a piece of communication data under a piece of specific configuration information estimated using a second estimation part 22b which will be described later.

The control part 12 and the control part 22 are realized using a central processing unit (CPU), a micro processing unit (MPU), or the like executing various programs stored in a storage device in each device using a RAM as a working region. Moreover, the control part 12 and the control part 22 are realized using an integrated circuit such as an application specific integrated circuit (ASIC) or a field programmable gate array (FPGA).

The control part 12 of the learning device 10 includes an acquisition part 12a and a first estimation part 12b, and optionally a compression part 12c. The acquisition part 12a acquires a piece of communication data associated with a piece of configuration information of the device. For example, the acquisition part 12a acquires a feature amount of a piece of communication data such as a piece of flow information and a piece of packet information to be learned and a feature amount of pieces of device configuration information such as protocols, SBOMs, and source codes corresponding to the feature amount of each piece of communication data and stores them in the acquisition information storage part 13a.

Here, for example, a code or the like which can uniquely identify each feature amount of a piece of communication data is assigned to it and the same code as the code is assigned to the feature amount of the piece of corresponding a piece of configuration information, thereby linking the piece of configuration information of the device and the piece of communication data. Note that a feature amount of one piece of communication data may be linked to a feature amount of a plurality of pieces of configuration information and a feature amount of one piece of configuration information may be linked to a feature amount of a plurality of pieces of communication data.

Also, the acquisition part 12a may acquire a piece of communication data associated with the piece of data of the piece of configuration information compressed using the compression part 12c. For example, the acquisition part 12a acquires the feature amount of the piece of configuration information, the dimension of which has been compressed to a lower dimension by the compression part 12c which will be described later in a state associated with the feature amount of the piece of communication data.

The first estimation part 12b estimates the probability density of the piece of communication data in accordance with the type of piece of configuration information and updates the parameters of a model which represents the characteristics of the probability density of a piece of normal communication data. For example, the first estimation part 12b refers to the piece of information stored in the acquisition information storage part 13a and estimates the probability density of the piece of communication data under a piece of specific configuration information using the feature amount of the piece of communication data linked to the type of feature amount of the piece of specific configuration information. Furthermore, the first estimation part 12b updates the model parameters of the probability density estimator in accordance with, for example, the learning result of the piece of communication data and stores pieces of information such as the updated parameters in the model information storage part.

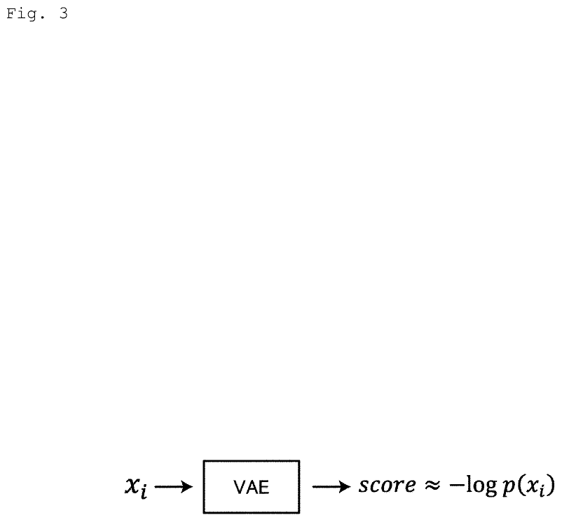

In addition, the first estimation part 12b estimates the probability density of the piece of learning target data using, for example, a variational auto encoder (VAE) as a probability density estimator. Here, a VAE will be described with reference to FIG. 3. FIG. 3 is a diagram showing the VAE.

As shown in FIG. 3, when a VAE receives an input of a data point “x(i)”, it outputs an anomaly score (degree of abnormality) corresponding to that piece of data. If the probability density is “p(x(i))”, the anomaly score is an approximation of “−logp (x(i))”. In this way, the higher the anomaly score output by the VAE, the more abnormal the communication data is.

The first estimation part 12b has, for example, a VAE which performs the above-described calculation, learns about the piece of stored communication data and outputs an anomaly score for each piece of communication data under the condition of a piece of specific configuration information. Also, the first estimation part 12b updates the model parameters of the VAE in accordance with the learning result.

The compression part 12c compresses the dimensions of a piece of data regarding the piece of configuration information. For example, the compression part 12c compresses the dimension of a piece of data regarding the feature amount of piece of configuration information using a compressor suitable for each type of a piece of configuration information. Here, the compressor suitable for each type of piece of configuration information refers to, for example, CodeBERT or the like when the type of piece of configuration information relates to a code and refers to Embedding or the like when the type of a piece of configuration information relates to SBOM or a protocol.

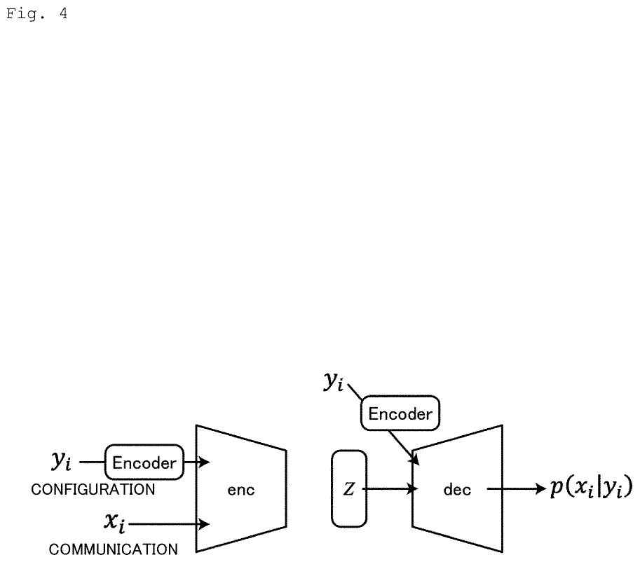

Here, referring to FIG. 4, a probability density estimation under a specific condition in the VAE included in the learning device 10 described above will be described. FIG. 4 is a diagram showing the conditional probability density estimation process according to the embodiment. In the example in FIG. 4, the feature amount of the piece of communication data is used for “x” and the feature amount of the piece of configuration information is used for “y”. Also, when inputting “y”, the input is passed through the compressor “Encoder” to compress the dimension.

In the example in FIG. 4, the data point “x(i)” in the encoder part “enc” of the VAE and a piece of configuration information “y(i)” corresponding thereto are input and trained. Also, after learning the data, by inputting a piece of specific configuration information “y(i)” to the decoder part “dec”, the probability density “p(x(i)|y(i))” under the condition of the piece of configuration information “y(i)” is estimated.

The control part 22 of the detection device has a reception part 22a, a second estimation part 22b, and a detection part 22c and may have the compression part 12c described above as necessary. The reception part 22a receives the piece of configuration information. For example, the reception part 22a receives a designation of a piece of specific configuration information from the outside and stores a piece of information on the designation of the piece of configuration information in the reception information storage part 23a. Note that the piece of configuration information to be received is any piece of configuration information learned using the above-described learning device and the reception part 22a may receive a plurality of pieces of configuration information.

Furthermore, the reception part 22a may also receive a piece of data of a piece of configuration information compressed using the compression part 12c. For example, the reception part 22a receives, as the designation of a piece of configuration information, a feature amount of a piece of configuration information whose dimensions have been compressed to a lower dimension by the above-described compression part 12c.

The second estimation part 22b estimates the probability density of the piece of communication data of the detection target by applying the parameters of the model updated in accordance with the piece of configuration information received by the reception part 22a. The second estimation part 22b uses the above-described VAE and applies the model parameters of the VAE updated in accordance with the conditions of the configuration information stored in the reception information storage part 23a to estimate the anomaly score of the piece of communication data to be detected.

Also, the second estimation part 22b stores the estimation result in the estimation information storage part 23b.

The detection part 22c detects the presence or absence of an abnormality in the piece of communication data of the detection target on the basis of the probability density estimated using the second estimation part 22b. For example, when the anomaly score estimated using the second estimation part 22b is higher than a preset threshold value, the detection part 22c detects that the piece of communication data to be detected is abnormal. Note that the above-described threshold value is an optimum value for detecting abnormal communication data which is set in advance from outside in accordance with the piece of communication data, the piece of configuration information, and the like.

### 3. Specific Example of Detection Process

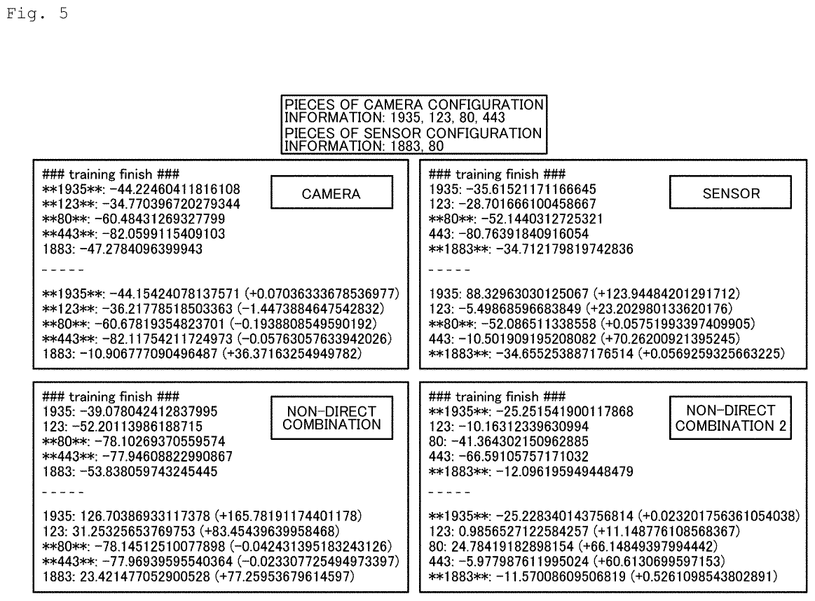

Here, an inspection process of a piece of configuration information of the device using the detection system 1 will be described using the example of FIG. 5. FIG. 5 is a diagram showing a specific example of a detection process according to an embodiment. In the example of FIG. 5, a protocol list is used as configuration information and a VAE is used as a probability density estimator. In addition, the encoder part of the VAE performs 1hot processing and is composed of a single-layer neural network. Furthermore, the VAE is learned on a piece of communication data from three camera devices in a collective manner and one sensor device and the average anomaly score is calculated for each protocol using probability density estimation.

In the example of FIG. 5, the change in the anomaly score when the detection system 1 receives a piece of configuration information for each of the “camera (upper left side on the drawing)” and the “sensor (upper right side on the drawing)”, the “non-direct combination (lower left side on the drawing)”, and the “non-direct combination 2 (lower right side on the drawing)” is shown using corresponding drawings. Here, the piece of camera configuration information is “1935, 123, 80,443” and the piece of sensor configuration information is “1883, 80”.

Also, in the example of FIG. 5, the piece of information above “ [symbol] ” in the center of each drawing indicates the average anomaly score when a piece of configuration information is not accepted and the piece of information below “ [symbol] ” indicates the average anomaly score when a piece of configuration information is received.

In the following description, as an example, a change in the anomaly score when a piece of camera configuration information is received will be described. In the upper left diagram of FIG. 5, the anomaly score when learning a piece of communication data between three camera devices and one sensor is “−44.22 . . . ” for the piece of configuration information “1935”, similarly, “−34.77 . . . ” for “123”, and “−47.27 . . . ” for “1883”.

Also, when the detection system 1 receives “1935, 123, 80, 443” as the piece of camera configuration information, the anomaly score “−44.15 . . . ” is for the piece of configuration information “1935”, the anomaly scores “−36.21 . . . ” is for “123”, and the anomaly score “−10.90 . . . ” is for “1883”. That is to say, it can be seen that the anomaly score for a piece of configuration information “1883” increases significantly between before and after the piece of configuration information is received. Note that an “*” next to the piece of configuration information indicates whether the piece of configuration information has been received.

As described above, the higher the anomaly score, the more abnormal the piece of communication data is determined to be. Thus, if the detection system 1 sets a preset threshold value of, for example, “−30”, it can detect only the piece of communication data of a piece of configuration information “1883” as abnormal. That is to say, the detection system 1 can detect as an anomaly only the piece of communication data for “1883” which is not received as the piece of configuration information of the camera.

Similarly, for the “sensor” (upper right) in the example of FIG. 5, there is almost no change in the anomaly scores for the piece of configuration information “1883” and “80” which are received as a piece of sensor configuration information, whereas there is a significant increase in the anomaly scores for the piece of unreceived information “1935”, “123”, and “443”. For this reason, by setting the threshold value to “20”, the detection system 1 can detect a piece of communication data regarding a piece of unreceived configuration information as being abnormal.

Furthermore, the detection system 1 can receive a piece of configuration information of combinations which do not directly exist other than combinations of pieces of camera configuration information and combinations of pieces of sensor configuration information. For example, in the “non-direct combination” at the bottom left of FIG. 5, the pieces of configuration information “80” and “443” are received, and in the “non-direct combination 2” at the bottom right of FIG. 5, the pieces of configuration information “1935” and “1883” are received. In both combinations, the anomaly score of the piece of unreceived configuration information increases significantly. Thus, the piece of communication data for that piece of information can be detected as abnormal.

### 4. Example of Process for Detection System

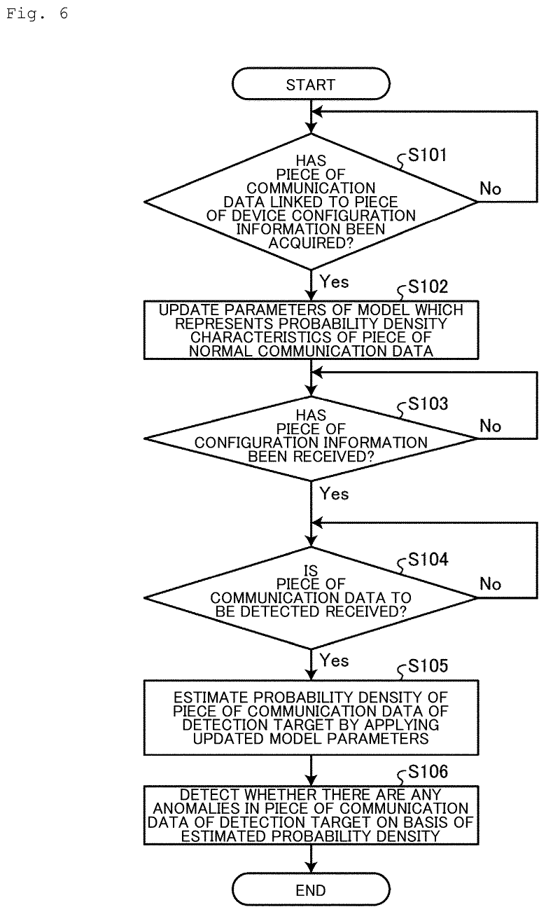

A detection process of the detection system 1 will be described below with reference to FIG. 6. FIG. 6 is a flowchart for describing an example of a process flow of a detection system according to an embodiment. First, the acquisition part 12a acquires a piece of communication data associated with the piece of configuration information of the device (Step S101).

When a piece of communication data linked to the piece of configuration information of the device is acquired (Step S101; Yes), the first estimation part 12b estimates the probability density of the piece of communication data in accordance with the type of a piece of configuration information and updates the parameters of a model representing the characteristics of the probability density of a piece of normal communication data (Step S102).

On the other hand, when the piece of communication data associated with the piece of configuration information of the device has not been acquired (Step S101; No), the acquisition part 12a waits until the piece of communication data associated with the piece of configuration information of the device is acquired.

Also, the reception part 22a receives the piece of configuration information designated from the outside (Step S103). When a piece of configuration information specified from the outside is received (Step S103; Yes), the detection device 20 receives a piece of communication data to be detected (Step S104). On the other hand, when the piece of configuration information specified from the outside has not been received (Step S103; No), the reception part 22a waits until the piece of configuration information specified from the outside is received.

When the piece of data of the detection target is received (Step S104; Yes), the second estimation part 22b applies the updated model parameters to estimate the probability density of the piece of communication data of the detection target (Step S105). On the other hand, when the piece of communication data to be detected has not been received (Step S104; No), the detection device 20 waits until the piece of communication data to be detected is received.

After that, the detection part 22c detects the presence or absence of an abnormality in the piece of communication data of the detection target on the basis of the estimated probability density (Step S106) and the detection system 1 ends the process.

### 5. Effects of Embodiment

As described above, the learning device 10 according to the embodiment has an acquisition part 12a which acquires a piece of communication data linked to a piece of configuration information of the device and a first estimation part 12b which estimates the probability density of the piece of communication data in accordance with the type of a piece of configuration information and updates parameters of a model which represents the characteristics of the probability density of a piece of normal communication data.

Thus, in the related art, for each device, one learning device learns the piece of communication data corresponding to the device, whereas the learning device 10 can learn a piece of communication data linked to a piece of configuration information from various devices and generate a communication monitoring model according to the piece of configuration information, thereby achieving the effect of reducing the vulnerable initial learning time required until the learning model is generated.

In addition, in the related art, one learning device is used for each device to learn communication data and generate a model corresponding to the device, whereas by learning various communication data, the learning device 10 becomes capable of monitoring communications of various devices by inputting corresponding configuration information, thereby achieving the effect of reducing the work of preparing corresponding learning devices and generating models as the number of devices to be monitored increases.

Also, as described above, the detection system 1 according to the embodiment includes the learning device 10 and the detection device 20 described above. The detection device 20 has a reception part 22a which receives a piece of configuration information, a second estimation part 22b which estimates a probability density of the piece of communication data of the detection target by applying model parameters updated in accordance with the piece of configuration information received using the reception part 22a, and a detection part 22c which detects the presence or absence of an abnormality in the piece of communication data of the detection target on the basis of the probability density estimated using the second estimation part 22b.

Thus, the detection system 1 has the effect of using a communication monitoring model under a piece of specific configuration information generated using the learning device 10 to determine that only communications linked to a piece of specific configuration information are normal from the piece of communication data to be detected and detecting other communications as abnormal.

Furthermore, the learning device 10 or the detection device 20 of the detection system 1 further has a compression part 12c which compresses the dimensions of the piece of configuration information data, the acquisition part 12a acquires a piece of communication data linked to the piece of configuration information data compressed using the compression part 12c, and the reception part 22a receives the piece of configuration information data compressed using the compression part 12c.

Thus, the detection system 1 can acquire or receive a piece of configuration information in a dimensionally compressed state, thereby advantageously reducing the calculation load of the probability density estimation process performed using the probability density estimator.

### 6. System Configuration or Like

Among the various processes described in the above embodiment, some of the processes described as being performed automatically can also be performed manually. Alternatively, all or a part of the processing described as being performed manually can be performed automatically in a known manner. In addition, the information including the processing procedures, specific names, various pieces of data and parameters shown in the above documents and drawings can be changed arbitrarily unless otherwise specified. For example, the various pieces of information shown in each drawing are not limited to the information shown in the drawings.

Furthermore, each constituent element of each device shown in the drawings is merely a functional concept and does not necessarily have to be physically configured as shown in the drawings. That is to say, the specific form of distribution and integration of each device is not limited to that shown in the drawing and all or a part of it can be functionally or physically distributed and integrated in any unit depending on various loads, usage conditions, or the like. Furthermore, each processing function performed by each device may be realized, in whole or in part, by a CPU and a program analyzed and executed by the CPU or may be realized as hardware using wired logic.

For example, a part or all of the storage part 13 or the storage part 23 shown in FIG. 2 may not be held by the learning device 10 or the detection device 20, but may be held in a storage server or the like. In this case, the learning device 10 or the detection device 20 accesses the storage server to obtain various pieces of information.

### 7. Hardware Configuration

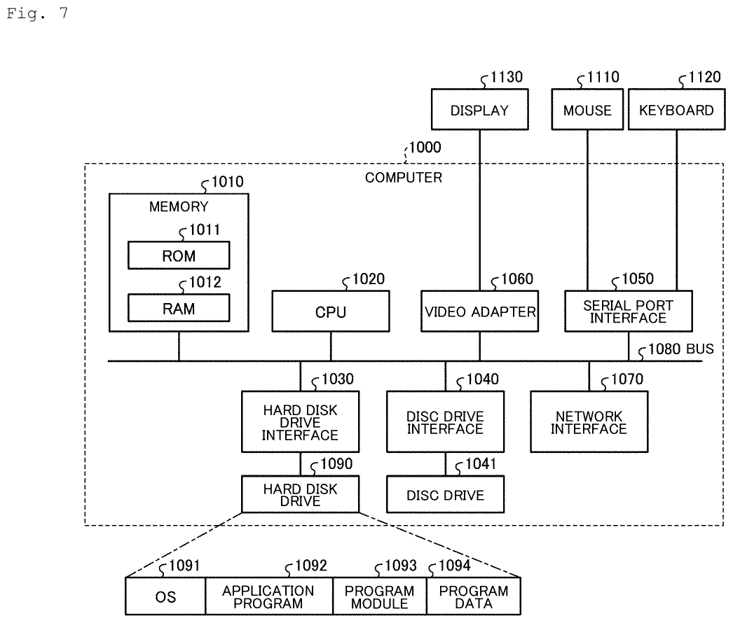

FIG. 7 is a diagram showing an example of a hardware configuration. The learning device 10 according to the embodiment described above is, for example, realized using a computer 1000 having a configuration as shown in FIG. 7.

FIG. 7 is a diagram showing an example of a computer which executes a learning program. The computer 1000 includes, for example, a memory 1010 and a CPU 1020. The computer 1000 also has a hard disk drive interface 1030, a disk drive interface 1040, a serial port interface 1050, a video adapter 1060, and a network interface 1070. Each of these parts is connected via a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1041. For example, a removable storage medium such as a magnetic disk or an optical disc is inserted into the disk drive 1041. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, application programs 1092, program modules 1093, and pieces of program data 1094. That is to say, the program which defines each process of the learning device 10 is implemented as a program module 1093 in which codes executable using the computer 1000 is written. The program module 1093 is stored on, for example, the hard disk drive 1090. For example, a program module 1093 for executing processes similar to those of the functional configuration of the learning device 10 is stored in the hard disk drive 1090. Note that the hard disk drive 1090 may be replaced by a solid state drive (SSD).

Furthermore, setting data used in the processes of the above-described embodiments is stored as program data 1094 in, for example, the memory 1010 or the hard disk drive 1090. Also, the CPU 1020 reads out the program module 1093 and the pieces of program data 1094 stored in the memory 1010 and the hard disk drive 1090 into the RAM 1012 as necessary and performs them.

Note that the program module 1093 and the pieces of program data 1094 are not limited to being stored in the hard disk drive 1090, but may also be stored in, for example, a removable storage medium and read by the CPU 1020 via the disk drive 1041 or Alternatively, the program modules 1093 and the pieces of program data 1094 may be stored in another computer connected via a network (LAN, WAN, or the like). Also, the program module 1093 and the pieces of program data 1094 may be read by the CPU 1020 via the network interface 1070 from another computer.

### REFERENCE SIGNS LIST

1 Detection system
10 Learning device
11, 21 Communication part
12, 22 Control part
12a Acquisition part
12b First estimation part
12c Compression part
13, 23 Storage part
13a Acquisition information storage part
13b Model information storage part
22a Reception part
22b Second estimation part
22c Detection part
23a Reception information storage part
23b Estimation information storage part

1. A learning device comprising:
a memory; and
processing circuitry configured to:
acquire a piece of communication data associated with a piece of configuration information of a device; and
estimate a probability density of the piece of communication data in accordance with a type of the piece of configuration information and update parameters of a model which represents characteristics of the probability density of a piece of normal communication data.

2.-3. (canceled)

4. A learning method performed using a learning device, comprising:
acquiring a piece of communication data associated with a piece of configuration information of a device; and
estimating a probability density of the piece of communication data in accordance with a type of the piece of configuration information and updating parameters of a model which represents characteristics of the probability density of a piece of normal communication data.

5. A non-transitory computer-readable recording medium storing therein a learning program that causes a computer to execute a process comprising:
acquiring a piece of communication data associated with a piece of configuration information of a device; and
estimating a probability density of the piece of communication data in accordance with a type of the piece of configuration information and updating parameters of a model which represents characteristics of the probability density of a piece of normal communication data.
